(19) United States
(12) Patent Application Publication
(10) Pub. No.: US 2025/0346529 A1
(43) Pub. Date: Nov. 13, 2025

(54) SEWAGE SLUDGE ASH (SSA) FOR LOW STRENGTH CONCRETE

(71) Applicant: Qatar Foundation for Education, Science and Community Development, Doha (QA)

(72) Inventors: Khaled Hassan, Doha (QA); Mohammed Saif Al-Kuwari, Doha (QA)

(21) Appl. No.: 19/187,179

(22) Filed: Apr. 23, 2025

Related U.S. Application Data
(60) Provisional application No. 63/644,184, filed on May 8, 2024.

(51) Int. Cl. C04B 18/10; C04B 14/06; C04B 22/00; C04B 28/04; C04B 103/10; C04B 103/32; C04B 111/00

(52) U.S. Cl. CPC C04B 18/103; C04B 14/06; C04B 22/0006; C04B 28/04; C04B 2103/10; C04B 2103/32; C04B 2111/00767

(57) ABSTRACT

Approximately 50,000 tons of sewage sludge are generated in Qatar every year as by-product from the treatment of municipal wastewater. The sewage sludge contains a wide range of contaminants, such as heavy metals, pathogens, and organic pollutants, and its disposal presents significant challenges due to its potential impact on human health and the environment. Thermally dried sludge pellets are only permitted for use in landscaping and their use is declining with time, with the majority sent to landfill. The government is considering the ban of sewage sludge landfilling due to the potential risks of accumulated contaminants. The present technology provides an innovative solution for the conversion of sewage sludge into cementitious material for use in the construction industry.

### PRIORITY CLAIM AND CROSS-REFERENCE TO RELATED APPLICATIONS

The present application claims priority to and the benefit of U.S. Provisional Patent Application No. 63/644,184 filed May 8, 2024, which is incorporated herein by reference in its entirety and relied upon.

### BACKGROUND

Approximately 50,000 tons of sewage sludge waste (dry weight) are generated annually as by-product from the treatment of municipal wastewater in Qatar. Sewage sludge contains a wide range of contaminants, such as heavy metals, pathogens, and organic pollutants, and its disposal presents significant challenges due to its potential impact on human health and the environment. Up to 48% of the generated sludge is thermally dried to produce pellets for landscaping and the remaining is sent to landfills. The use of sludge pellets in landscaping is declining with government plan to restrict landfilling.

Sewage sludge is one of the main solid waste materials in Qatar with great interest worldwide for effective waste management in a circular economy. Landfilling of organic waste without appropriate treatment can pollute the surrounding air, soil, and groundwater environments. When organic landfilled wastes decompose, they create methane gas (CH4), which is very explosive and flammable. Another significant landfilling concern is leachate management, where heavy metals can become mixed with and contaminate surface waters, groundwater and soils. Inappropriate waste disposal can also attract mice and flies that carry infectious diseases, causing severe environmental health consequences due to pollution and spread of diseases. Dried waste materials, especially fine particles may be resuspended by wind and spreading diseases to different locations.

Incineration of sewage sludge is gaining attention with the potential use of incinerated sewage sludge ash (SSA) in construction. SSA can be used as a partial replacement for cement in concrete production, thus addressing the environmental concerns associated with sludge disposal, and reducing the demand for traditional Portland cement (PC), which is a significant source of greenhouse gas emissions.

The present technology is a green cement developed from local solid waste of sewage sludge ash (SSA). The green cement is used for the development of high-value construction products for effective waste management and reduced reliance on Portland cement (PC) and natural resources. The proposed technology is aligned with the Qatar National Environment and Climate Change Strategy of Waste Management and Circular Economy.

### SUMMARY

Example systems, methods, and apparatus are disclosed herein for sewage sludge ash (SSA) for low strength concrete.

In light of the disclosure herein, and without limiting the scope of the invention in any way, in a first aspect of the present disclosure, which may be combined with any other aspect listed herein unless specified otherwise, a green cement concrete block comprised of sewage sludge ash (SSA), Portland cement (PC), aggregates, chemical activator, and water.

In a second aspect of the present disclosure, which may be combined with any other aspect listed herein unless specified otherwise, the green cement block is 10% SSA.

In a third aspect of the present disclosure, which may be combined with any other aspect listed herein unless specified otherwise, the chemical activator is one of sodium hydroxide, sodium silicate, or cement kiln dust (CKD).

In a fourth aspect of the present disclosure, which may be combined with any other aspect listed herein unless specified otherwise, the chemical activator is CKD, and the green cement block is 10% CKD.

In a fifth aspect of the present disclosure, which may be combined with any other aspect listed herein unless specified otherwise, the green cement block has an alkali content of 6%.

In a sixth aspect of the present disclosure, which may be combined with any other aspect listed herein unless specified otherwise, the aggregates is natural rock or gravel or sand or recycled aggregates.

In a seventh aspect of the present disclosure, which may be combined with any other aspect listed herein unless specified otherwise, further comprising superplasticizer, the green cement block is 2% superplasticizer.

In an eighth aspect of the present disclosure, which may be combined with any other aspect listed herein unless specified otherwise, a green foam concrete comprised of sewage sludge ash (SSA), Portland cement (PC), superplasticizer (SP), foaming agent, sand, and water.

In a ninth aspect of the present disclosure, which may be combined with any other aspect listed herein unless specified otherwise, the green foam concrete is 40% SSA.

In a tenth aspect of the present disclosure, which may be combined with any other aspect listed herein unless specified otherwise, the foaming agent is synthetic foam.

In an eleventh aspect of the present disclosure, which may be combined with any other aspect listed herein unless specified otherwise, the superplasticizer dosage is 2.5 l/m³.

In a twelfth aspect of the present disclosure, which may be combined with any other aspect listed herein unless specified otherwise, the foaming agent dosage is between 1.2 and 1.4 kg/m³.

In a thirteenth aspect of the present disclosure, which may be combined with any other aspect listed herein unless specified otherwise, the sand content is 260 kg/m³.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows sewage sludge cake (left) and thermally dried sludge pellets (right), according to an example embodiment of the present disclosure.

FIG. 2 shows testing for fresh paste and mortar samples, according to an example embodiment of the present disclosure.

FIG. 3 shows dry concrete mixtures for the production of concrete blocks, according to an example embodiment of the present disclosure.

FIG. 4 shows mixing and flow table of foam concrete, according to an example embodiment of the present disclosure.

FIG. 5 shows XRD of SSA (top), according to an example embodiment of the present disclosure.

FIG. 6 shows XRD of hydrated PC samples, according to an example embodiment of the present disclosure.

FIG. 7 shows XRD of hydrated SSA samples, according to an example embodiment of the present disclosure.

FIG. 8 shows XRD of hydrated SSA and PC samples, according to an example embodiment of the present disclosure.

FIG. 9 shows SEM image of a 90 days hydrated SSA sample, SEM, Elemental analysis performed on highlighted areas, according to an example embodiment of the present disclosure.

FIG. 10 shows EDX elemental analysis of the large particle from 90 days hydrated SSA sample, according to an example embodiment of the present disclosure.

FIG. 11 shows SEM image of a 90 days hydrated SSA+Portland sample, SEM, Elemental analysis performed on highlighted areas, according to an example embodiment of the present disclosure.

FIG. 12 shows EDX elemental analysis of the large area highlighted from 90 days hydrated SSA+Portland cement sample, according to an example embodiment of the present disclosure.

FIG. 13 shows production of concrete blocks, pressure machine (left), curing and final products (right), according to an example embodiment of the present disclosure.

FIG. 14 shows SSA foam concrete for road reinstatement around manhole covers, according to an example embodiment of the present disclosure.

### DETAILED DESCRIPTION

The present disclosure generally relates to technology and associated methods for using sewage sludge ash (SSA) to create green cement. Specifically, the disclosed technology is aimed at developing an innovative green cement from solid waste, accumulated in Qatar.

Large quantities of solid waste materials are produced in Qatar every year, which could be successfully used to support the government strategy of sustainable construction that preserves natural resources and the environment. Transforming waste from landfills to useful construction products and preserving the use of energy-intensive Portland cement (PC) will open up new opportunities for resource recovery, circular economy and sustainable development within the construction industry in Qatar.

Researchers have reported the potential use of SSA in various construction applications. The major components of SSA are SiO₂, CaO, Al₂O₃, Fe₂O₃, MgO and P₂O₅, making it suitable for use as a pozzolanic material when finely ground. Researchers have also investigated the properties of bricks manufactured with sewage sludge and clay. The sewage sludge was found to improve the dimensional stability of the fresh (molded) mixtures by reducing the plastic index and drying shrinkage. Bricks made with 10% sludge exhibited higher compressive strength than normal clay bricks. Research showed that the sludge proportion and the firing temperature were the two key factors determining the brick quality. As such, research recommended proportion of SSA in brick is 10%, with a 24% optimum moisture content, prepared in the molded mixtures and fired between 880-960° C. to produce a good quality brick.

The pozzolanic activity of SSA for use as cement replacement material was also investigated. Research found that the workability and early compressive strength of mortar reduced with increasing the amount of SSA as a cement replacement. It was recommended that the maximum replacement level of Portland cement with SSA should not exceed 20%. The irregular morphology of SSA particles decreased the mortar workability. A nonlinear reduction of workability in mortars containing SSA was observed, but when SSA content in mortars was increased the workability reduction was less significant.

Incinerated sewage sludge ashes (SSA) were used for the stabilization of wet sludge in landfill sites with improving the leaching and environmental properties of soil. Researchers mixed fresh sewage sludge (wet) with incinerated SSA and recycled aggregates to obtain “Controlled Low-Strength Materials,” with a compressive strength in the range of 0.5 to 2.5 MPa. Analysis of the chemical composition of water leachates from samples of the composite showed that it is inert, and thus does not pose a threat to the environment. The observed decrease in the concentrations of the pollutants with time indicated that the latter are immobilized in the hydration products. It was also reported the effect of SSA content (10-30% by weight) on the properties of mortar. SSA exhibited moderate pozzolanic activity and the highest strength was achieved with the lowest SSA content of 10%. Shrinkage data demonstrated that sulphates present in SSA are not reactive towards cement.

Unlike other cementitious materials, SSA is often rich in phosphates that may influence the hydration of cement. Researchers reported extended setting time for the SSA concrete and attributed to the presence of phosphorus in SSA. The compressive strength of 10% and 20% SSA mortars were lower than the control PC mortar, however, the long-term increase in compressive strength of mortar was higher compared to PC mortar. Increased SSA grinding time improved the workability of concrete, and the SSA reactivity is associated with CH consumption decreased from 29% to 16% in the first three days of curing. Mortars containing a 15% SSA cured at 40° C. for 14 and 28 days showed equal or higher compressive strength than the control mortar. Researchers used an isothermal conduction calorimeter and X-ray diffraction (XRD) to assess the hydration of cement pastes containing SSA and observed the presence of hydrated carboaluminates and aluminosilicates. Researchers also detected other minerals, such as monosulphates. Researchers reported the effect of SSA on delaying the setting time and lowering the strength of concrete. The high P₂O₅ content in SSA-cement mixtures reduces the compressive strength due to the decomposition of C₃S to obtain C₂S rich in P₂O₅, thus slows the hydration of calcium silicates and affects the strength characteristics of mortars. Researchers utilized a low Al content SSA and noted a nominal increase in strength at 90 days for substitutions up to 15%. This moderate improvement was not evident at earlier ages and was assigned to lower C₃A content and higher P₂O₅ content which influence the reactivity of C₃S.

Previous research on SSA in cementitious binders have been coined widely by strength and pozzolanic properties, with more focus on high strength concrete. There is a need for more research on the use of alternative binders, such as SSA, for use in low strength concrete applications. While PC is widely used in high-strength and high-performance concretes because of its ability to create strong and durable structures, its use in low strength concrete may be over-design and expensive. For example, cement bound materials are generally specified as low-strength concrete and a limitation on the maximum strength value. The use of alternative binders, such as fly ash, can reduced the strength of concrete and delay the setting time to enable increased shelf time for material handling and placing on site, especially in hot countries such as Qatar and the Gulf region. Therefore, the use of PC might lead to over-engineering and might not be the most economical choice. PC production is energy-intensive and generates significant carbon dioxide emissions, contributing to environmental concerns. In applications where sustainability and environmental impact are important considerations, reducing the use of Portland cement in favor of alternative materials can be beneficial.

As such, the disclosed technology aims for the development of green cement, made of solid waste materials, to reduce the environmental impact and costs, and tailor the properties of concrete mixes to specific requirements, including low-strength applications.

In the present technology, treated sewage sludge, from wastewater treatment plants, was incinerated and the residue ash, known as sewage sludge ash (SSA), was used as cement replacement in concrete applications. The effect of SSA on the fresh and hardened properties of concrete was investigated to develop innovative green construction products in compliance with the Qatar Construction Specification (QCS 2014) and relevant international standards.

SSA was initially activated by blending with other calcium-based materials of PC, hydrated lime, and cement kiln dust (CKD) and used for the production of low-strength concrete products of concrete blocks, foam concrete and cement bound materials. Microstructural analysis indicated pozzolanic reactivity of reactive alumina and sulfate in SSA with the calcium source in PC, hydrated lime and CKD to form ettringite and monosulphates (AFm) that contribute to the strength and enhanced pore structure of concrete. Full-scale site trials were conducted for the production of concrete blocks and foam concrete for the reinstatement of depressions around manholes in road pavement. The SSA concrete performed similar to the conventional concrete made with 100% PC.

The process of producing new green cement and green construction products involved different work packages (tasks) of assessing the physical and chemical characterization of main solid waste materials and identifying the most suitable for the development of green cement: activating the powder waste using different techniques to produce green cement: developing quality construction products: applying the newly developed products in full-scale site trials, monitoring performance in service, and quantifying the environment and cost benefits of the new products.

Work Package 1: Initial familiarization and characterization of the main solid waste materials available in Qatar with potential use for the development of green cement. The main wastes identified are sewage sludge, from municipal wastewater treatment plants, and incinerated municipal solid waste (incinerator bottom ash and incinerated fly ash). The physical and chemical characteristics of identified waste materials were investigated and compared to that of conventional Portland cement (PC), to identify the most suitable waste materials for the development of green cement. Sewage sludge gave the best performance within the solid waste materials investigated, and therefore was considered for the next phase for the development of different green cement systems.

Work Package 2: Development of concrete products. The main use of the green cement is to produce non-structural concrete applications. This task focused on the activation of SSA to produce different green cement systems. Different techniques were considered for the activation of SSA including blending with different proportions of PC, lime-activation, cement kiln dust activation, and alkali-activated materials. The properties of the green cement systems as well as the mortar fresh, hardened, and microstructural were analyzed to understand the cementitious behavior of the newly developed SSA concrete products.

Work Package 3: Full-scale site trials. Site trials were carried out to demonstrate how the newly developed products, made with the SSA green cement systems, could be applied to meet the required standards and comply with national specifications. Two site trials were considered for the proposed non-structural concrete applications to include concrete blocks and foam concrete. Site and laboratory tests were conducted during and after construction to assess performance and compliance with national specifications.

Work Package 4: Cost and environmental assessment. Work Package 4 included an assessment of the variability of main oxides of SSA that may influence its performance as a green cement, and the identification of other nutrients for potential resource recovery and circular economy. The effect of green cement on the immobilization of heavy metals, contained in the SSA, was investigated. A carbon footprint study was conducted to assess the greenhouse gas (GHG) emissions produced during the production of both the SSA and concrete products. Similarly, the cost associated with the processing and production of SSA was calculated and compared to that of conventional cementitious binders.

### Waste Materials for Green Cement:

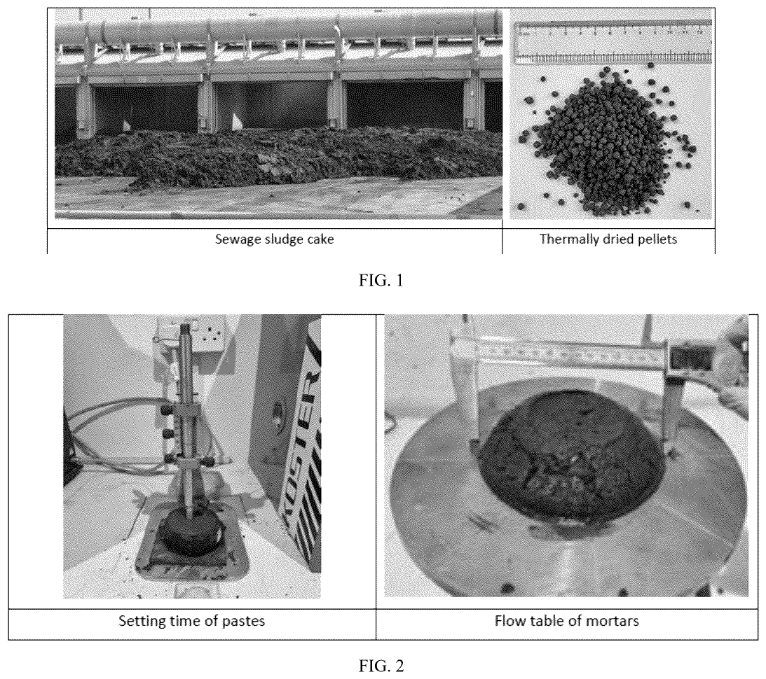

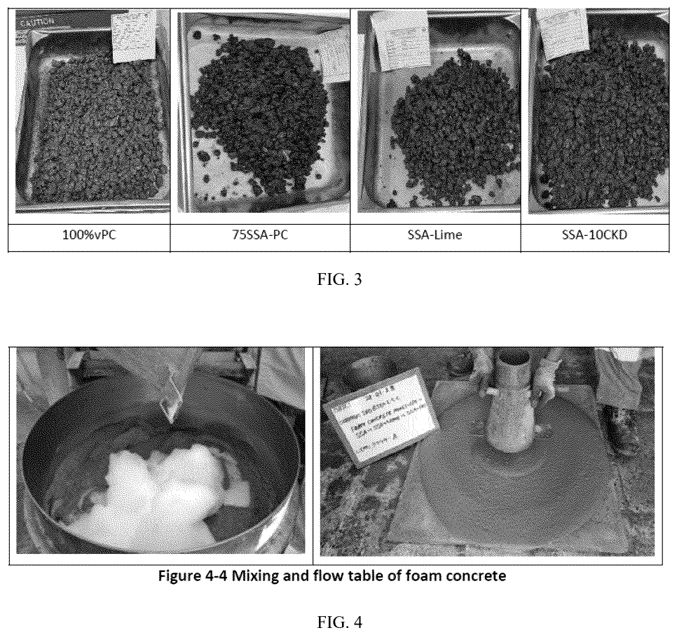

Three solid waste materials were initially identified for the development of green cement to include sewage sludge and municipal solid incinerated waste of bottom and fly ashes. The sewage sludge was obtained from the Doha North Sewage Treatment Works (DNSTW). It is produced as a by-product in the form of sludge cake, which is thermally dried to produce sludge pellets, size of 2-5 mm, as shown in FIG. 1. The sewage sludge pellets were incinerated in a furnace at 800-900° C. for 3 hours for the combustion of organic matters. The municipal solid waste of fly ash (MSW-FA) and bottom ash (MSW-BA) are by-products from the incineration of municipal solid waste materials. They were obtained from the Energy-from-Waste plant in the Domestic Solid Waste Management Centre (DSWMC).

The powder materials of incinerated solid wastes were initially investigated for particle size distribution, using the Malvern's Hydro LV Mastersizer 3000, and X-ray diffraction (XRD) for mineralogical compositions using the PANalytical X'Pert Pro MPD Diffractometer. The surface area of the powder materials was determined using the Blaine Fineness method as per BS EN 196-6 (2018). Thermogravimetric analysis (TGA) and Scanning electron Microscopy (SEM) were used to study the hydration products of the new green cement systems. TGA was used to identify and calculate the amount of hydrates developed within the different pastes, whereas the SEM was used study the microstructure and hydration of various SSA systems.

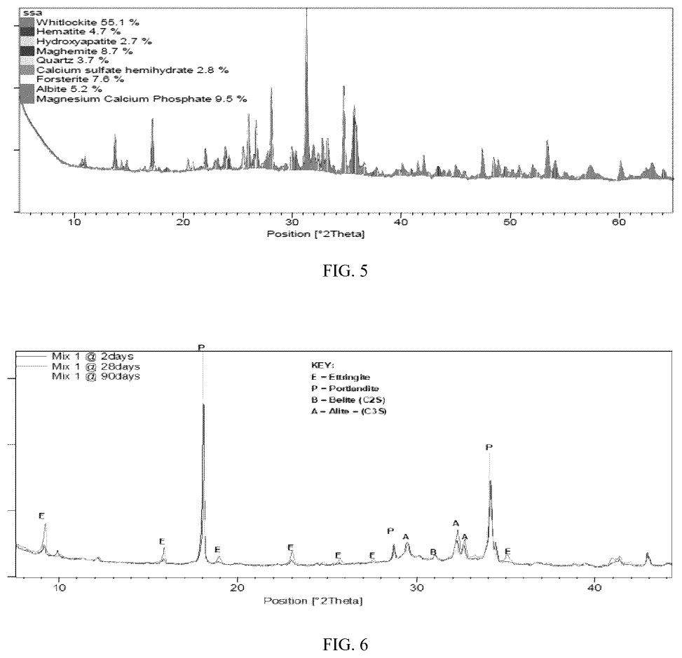

The fresh green cement systems, made with SSA, were assessed using the standard consistence and setting times of cement pastes as per BS EN 196-3 (2016). The consistency test defines the amount of water needed to achieve a comparable workability limit. whereas the setting time defines the specified time required for the paste to change from liquid state to plastic state and plastic state to solid state, i.e. harden to withstand a definite amount of pressure. The flow table test, to BS 4551-1 (1998), was used to assess the workability of the fresh mortar samples. FIG. 5 shows the equipment used for measuring the setting time of paste and flow table of mortar samples.

Mortar cubes and prisms were prepared of the required mix designs and cast into steel mold and compacted using a vibrating hammer, to simulate current practice for the compaction of dry mixtures for concrete blocks and cement bound materials. The hardened specimens were tested for compressive strength to BS EN 12390-3 (2019), drying shrinkage to BS EN 1367-4 (2008), expansion, and durability to hot water exposure. The compliance of testing was assessed against the national Qatar Construction Specifications (QCS, 2014). The environmental assessment for the leaching of heavy metals testing was conducted as per the USEPA 3050B (EPA, 1996), whereas the carbon footprints of the SSA green cement and concrete products were calculated following to the procedure described in PAS 2050 (BSI, 2011).

### Selection of Waste Materials:

Three solid waste materials were initiated used for the development of green cement to include SSA, MSW-IBA and MSW-FA, and their properties were compared to that of PC, and presented in Table 1. PC has the highest specific gravity, followed by the SSA, MSW-IBA and MSW-FA. Despite the finer grading of PC, it gave the lowest surface area of 3130 cm2/g. The MSW-FA, collected as dust from the hot flue gas, exhibited the highest surface area of 7220 cm2/g. The pH results indicate that all materials are alkalis, with PC exhibiting the highest alkalinity of 12.3 and the lowest of 9.8 for the MSW-IBA.

TABLE 1
Properites of waste materials and Portland Cement (PC).

| Property | MSW-FA | MSW-IBA | SSA | PC |
|---|---|---|---|---|
| SG | 2.61 | 2.66 | 2.99 | 3.17 |
| Blaine (cm²/g) | 7220 | 4670 | 4950 | 3130 |
| pH | 12.3 | 9.8 | 11.4 | 13.0 |
| Chloride (%) | 12.59 | 0.58 | 0.12 | 0.09 |
| SO₃ (%) | 7.0 | 0.7 | 0.9 | 3.3 |
| LOI (%) | 18.0 | 12.9 | 2.8 | 1.6 |

BS EN 197-1 (BSI, 2011) limits the chloride content of cementitious materials to a maximum of 0.1%. The results in Table 1 show that only PC complies with the chloride requirement, whereas the SSA gave a marginally higher value of 0.12%. MSW-FA exhibited the highest chloride content of 12.59%. BS EN 197-1 also limits the sulfate content (SO₃) to a maximum level of 3.5% and the loss on ignition (LOI) to a maximum of 5.0% by weight of the total binder content. Table 1 shows that all the waste materials contain less than 3.5% of SO₃, except the MSW-FA which contains a high sulfate content of 7.0%. Only PC and SSA satisfied the BS EN 197-1 requirement of <5.0% LOI. The properties of investigated wastes indicate lack of compliance to BS EN 197-1, especially for the MSW-FA and MSW-IBA.

The waste materials were used to replace PC at different proportions of 25%, 50%, and 75% by weight of binders and their effects on the fresh and hardened properties of concrete were investigated. Paste specimens were used for testing the consistency and setting time. Mortar specimens were prepared in the weight proportions of 1:3:0.5 of cementitious material, sand, to water, respectively, and used for the determination of compressive strength at 2, 7, and 28 days. A summary of the mixtures and test results is given in Table 2.

TABLE 2
Properties of mixtures prepared with solid waste materials.

| | | Setting time | | Compressive strength | | | |
|---|---|---|---|---|---|---|---|
| | Consistency | (min) | | (MPa) | | | Strength factor |
| Mix | (%) | Initial | Final | 2 d | 7 d | 28 d | (k = fckₓ/fck_{PC}) |
| 100% PC | 26.5 | 135 | 210 | 22.9 | 36.6 | 44.8 | 1 |
| 25% FA | 27.0 | 45 | 75 | 11.7 | 20.0 | 30.4 | 0.68 |
| 50% FA | 28.5 | 30 | 75 | 0.0 | 8.5 | 17.5 | 0.39 |
| 75% FA | 31.0 | 15 | 45 | 0.0 | 0.0 | 5.3 | 0.12 |
| 25% IBA | 25.0 | 150 | 210 | 13.2 | 20.6 | 23.4 | 0.52 |
| 50% IBA | 26.0 | 195 | 225 | 3.9 | 11.3 | 11.6 | 0.26 |
| 75% IBA | 27.5 | 225 | 315 | 0.0 | 0.0 | 3.7 | 0.08 |
| 25% SSA | 25.0 | 180 | 255 | 21.6 | 30.6 | 37.1 | 0.83 |
| 50% SSA | 26.0 | 285 | 355 | 11.8 | 18.2 | 24.9 | 0.56 |
| 75% SSA | 26.5 | 375 | 625 | 0.0 | 5.3 | 7.6 | 0.17 |

The consistency of PC is 26.5% and the use of solid waste materials resulted is similar or higher consistency values. Increasing the FA content from 25% to 75% increased the consistency to 27% to 31%, respectively. FA had the highest particles surface area, almost double of PC, and would require more water to achieve the standard consistency. The IBA and SSA mixture had marginal effects on the standard consistency, compared to PC.

The initial and final setting times of the 100% PC are 135 and 210 minutes, respectively. The use of MSW-FA significantly reduced the setting time compared to PC, with high replacement level results in faster setting. In contrast, the use of MSW-IBA and SSA delayed the setting time. Increasing SSA replacement level resulted in a delay in both initial and final setting times. Replacing 75% of PC with SSA increased the initial and final setting times to 375 and 625 minutes, respectively, almost triple the values obtained for the control 100% PC. Similar findings on the retarding effect of SSA have been reported by previous studies due to the presence of phosphorus oxide. The delay in setting times may be an advantage in hot regions for use in specific applications.

The PC mortar attained compressive strength values of 22.9 MPa at 2 days (220 MPa) and 44.8 MPa at 28 days (242.5 MPa), and therefore classified as a Strength Class 42.5 R according to BS EN 197-1. The use of waste materials, as cement replacement, resulted in lower compressive strength, and the strength reduction is proportional to the replacement level.

The best compressive strength results among the investigated waste materials are found in the 25% SSA. The inclusion of SSA reduced the compressive strength but at a lower magnitude than the FA and IBA materials. Based on this preliminary testing, SSA was selected for further investigation for the development of green cement systems.

### Development of SSA Green Cement and SSA Concrete Mixes:

The SSA was activated using different techniques to include PC, hydrated lime (CH), cement kiln dust, and alkali solutions. Mortar mixtures were designed for similar workability, as measured by the flow table, and tested for compressive strength at the ages of 2, 7, 28, and 90 days. The results of flow table and compressive strength are given in Table 3.

TABLE 3
Summary of mortar results - SSA activated different techniques.

| | | Flow table | Compressive strength (MPa) | | | |
|---|---|---|---|---|---|---|
| Activation | Mix | (mm) | 2 days | 7 days | 28 days | 90 days |
| Portland cement | 100PC | 148 | 33.2 | 35.6 | 43.4 | 47.9 |
| (PC) | 75PC-25SSA | 134 | 22.7 | 25.3 | 35.1 | 31.7 |
| | 50PC-50SSA | 142 | 12.3 | 13.7 | 22.2 | 18.7 |
| | 25PC-75SSA | 138 | 8.9 | 9.8 | 14.9 | 16.5 |
| Hydrated lime | 90SSA-10CH | 147 | 0.5 | 2.0 | 2.8 | 3.8 |
| (CH) | 80SSA-20CH | 162 | 1.2 | 2.3 | 3.6 | 4.25 |
| | 70SSA-30CH | 180 | 1.1 | 2.1 | 3.0 | 4.5 |
| Cement Kiln Dust | SSA-5% CKD | 145 | 5.2 | 6.4 | 6.8 | 7.1 |
| (CKD) | SSA-10% CKD | 136 | 5.5 | 6.9 | 7.4 | 7.6 |
| | SSA-20% CKD | 120 | 5.6 | 6.4 | 7.2 | 7.5 |
| Alkali activated | SSA 8-1.5 | 138 | 6.0 | 7.0 | 6.3 | 5.8 |
| | SSA 6-1.5 | 171 | 6.8 | 8.2 | 8.4 | 7.3 |
| | SSA 4-1.5 | 135 | 3.3 | 3.6 | 5.8 | 5.1 |
| | SSA 8-1.0 | 130 | 5.3 | 6.3 | 8.7 | 7.6 |
| | SSA 6-1.0 | 161 | 3.1 | 3.7 | 5.3 | 5.8 |
| | SSA 4-1.0 | 150 | 1.9 | 2.3 | 3.3 | 5.4 |
| Alkali activated | 50% GGBS-8-1.5 | 136 | 27.0 | 29.3 | 25.4 | 24.1 |
| (50% SSA + 50% GGBS) | 50% GGBS-6-1.5 | 189 | 21.3 | 23.2 | 20.3 | 19.7 |
| | 50% GGBS-4-1.5 | 183 | 12.7 | 13.6 | 16.9 | 19.8 |

SSA was used for the development of mortar mixtures by replacing PC in the weight proportions of 0, 25%, 50%, and 75%. The results in Table 3 show that the addition of SSA has slight effect on the workability of mortars. The PC mortar mixture gave a 43.4 MPa at 28 days. The compressive strength decreased in proportional to the SSA content, as higher SSA content resulted in lower strength. The 28-day strength reduction was 19% for the 25% SSA and 66% for the 75% SSA mixtures. Hydrated lime was also used as an activator to SSA, and the workability of the SSA-CH system increases with increasing the lime content. The SSA-CH system exhibited low initial strength at 2 days of around 1.0 MPa, but the strength continues to develop with age to exceed 4 MPs at 90 days. Not much increment in strength is noticed with increasing the lime content from 20% to 30% in the SSA system.

CKD is another source of calcium and was used to activate the SSA as shown in Table 3. Increasing the CKD content adversely affected the workability of mortar. The SSA-CKD system exhibited relatively high strength development at 2 days, but the rate of strength development reduced with time for all mixtures. The best strength results were found for the SSA-10% CKD.

Chemical activators of sodium hydroxide (N) and sodium silicate (SS) were used to activate the SSA. A fixed liquid-to-binder ratio of 0.75 was used for all mixtures. The alkali (Na₂O) content and silicate modulus (Ms) of alkaline activator were varied, as shown in Table 3. A blend of 50% SSA and 50% GGBS was also activated with chemical solutions. No clear trend was found for the effect of chemical activators on the workability of SSA systems, but the best values were found at alkali content (N) of 6%. The compressive strength of the SSA activated systems were in the range of 1.9 MPa to 8.7 MPa, whereas a higher range of 12.7 MPa and 29.3 MPa for the SSA-GGBS system. The alkali-activated systems exhibited the general trend of increased strength with age, but mixtures with high alkali (6% and 8%) and high Ms (1.0 and 1.5) showed opposite trend after 28 days.

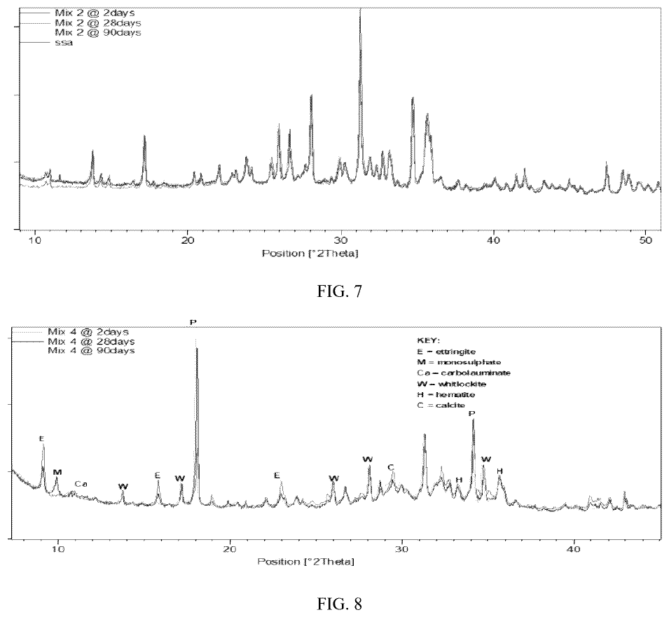

Microstructural analysis of the different systems and indicated a dense microstructure for the SSA-lime systems, FIG. 6, with the formation of calcium phosphates and calcium carbonate that contribute to the strength development of the mixture. The alkali-activated SSA systems with high silicate modulus (Ms of 1.5) showed similar hydration products to that of the SSA-lime systems, but with a porous microstructure and the presence of microcracks, especially for the high silicate modulus (Ms of 1.5) mixtures with high alkali content as shown in FIG. 7. The microcracks are attributed to the self-desiccation associated with the high alkali activation and the initial heat curing that reduced the moisture content within the mortar's structure. The SSA-alkali activated systems were not considered in the following stages of mix development.

Three construction products were developed from the green cement and tested for compliance with relevant specifications. SSA-activated systems were used to produce non-structural concrete products of blocks, foam concrete and cement bound materials.

SSA Concrete Blocks: the ratio of binder to fine aggregate to coarse aggregate was maintained at 1:3:6 (by weight) with a binder content of 270 kg/m³, and water to binder ratio of 0.5 Table 4 provides the binder proportions of the different mixtures, together with the results of compressive strength and water absorption. The control mixture was made with 100% PC binder, whereas the other mixtures were made with 25-90% SSA. Washed sand was used as fine aggregate (FA), whereas recycled aggregate was used as coarse aggregate (CA). A superplasticizer dosage of 2% was used for all mixtures. The mixtures were relatively dry, to enable immediate demolding after compaction.

TABLE 4
Mixtures of the concrete blocks made with SSA green cement.

| | | | | | 7-Day Results | |
|---|---|---|---|---|---|---|
| | Binder | | | | Strength | Absorption |
| Mix | SSA | PC | CKD | Lime | (MPa) | (%) |
| 100% PC | — | 1 | — | — | 23.0 | 3.5 |
| SSA-75PC | 0.25 | 0.75 | — | — | 18.3 | 5.1 |
| SSA-20Lime | 0.8 | — | — | 0.2 | 5.8 | 5.6 |
| SSA-10CKD | 0.9 | — | 0.1 | — | 7.5 | 5.1 |

For concrete blocks, the QCS 2014 specifies a minimum average compressive strength of 10.4 MPa for load bearing walls, 7.0 MPa for external non-load bearing walls, and 4.0 MPa for internal non-load bearing walls. Current practice in Qatar is to use 7.0 MPa for both external and internal non-load bearing walls. The QCS also specifies a maximum average water absorption of 7.0% as per the CML Method 9-97 (1997). The results in Table 4 show that the control 100% PC and SSA-75% PC mixtures easily achieve the QCS requirements of compressive strength and water absorption. The SSA-10CKD slightly exceeded the strength requirement, whereas the SSA-20Lime failed to achieve the required strength. Based on the results, the SSA-PC system was selected for the development of the concrete blocks. FIG. 8 shows dry concrete mixtures for the production of concrete blocks.

SSA Foam Concrete: Foam concrete mixtures were developed through the use of PC as an activator for SSA at different replacement levels. Table 5 presents the mix composition of the foam concrete mixtures. The control mixture was made with 100% PC, whereas the SSA mixtures were made by replacing 50% and 25% of PC. The sand content, water/binder (w/b), and superplasticizer dosage were maintained the same for all mixtures at 260 kg/m³, 0.88, and 2.5 l/m³, respectively. The amount of foam was adjusted between 1.2 to 1.4 kg/m³ to give similar workability and air voids to the mixtures.

TABLE 5
Mix proportions of SSA foam concrete (kg/m³).

| | Binder | | | | | |
|---|---|---|---|---|---|---|
| Mix | PC | SSA | Sand | w/b | SP (l/m³) | Foam |
| Control-100PC | 260 | — | 1530 | 0.88 | 2.5 | 1.4 |
| SSA-50PC | 130 | 130 | 1530 | 0.88 | 2.5 | 1.3 |
| SSA-75PC | 195 | 65 | 1530 | 0.88 | 2.5 | 1.2 |

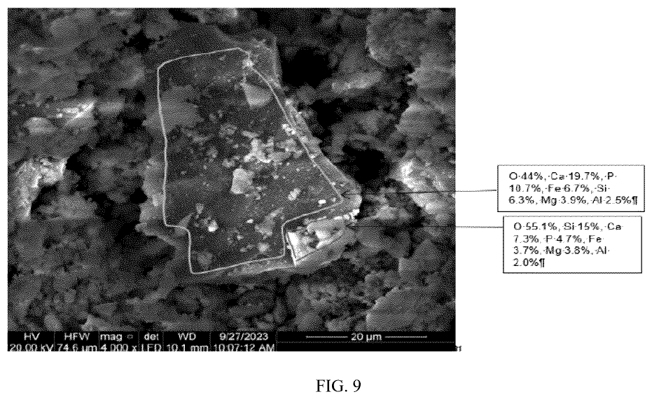

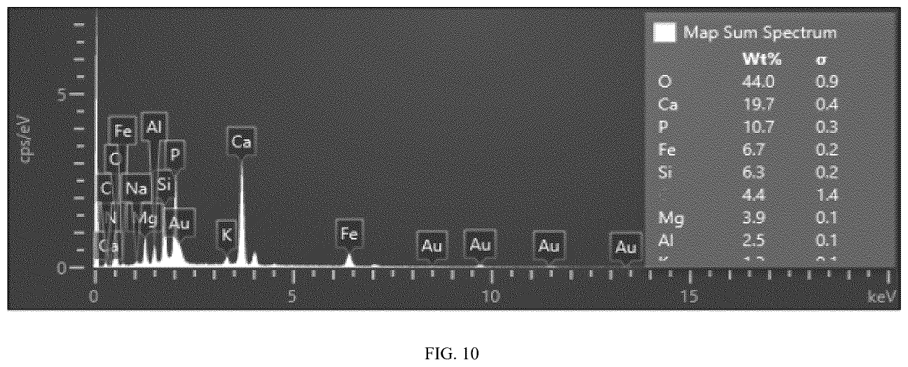

The mixing of foam concrete, adding the foaming agent to the mortar, and the workability measurement are shown in FIG. 9. The fresh and hardened properties of foam concrete mixtures are given in Table 6, including the wet density, air content, slump, flow table, as well as the hardened properties of compressive strength and dry density at different ages. The wet density ranged from 1610-1760 kg/m³, for lightweight foam concrete, and the air content from 20% to 25%. All the mixture were flowable as shown by the slump and flow table testing. The FC mixtures were highly flowable with high air content and stability, with no segregation or bleeding.

TABLE 6
Fresh and hardened properties of foam concrete mixtures.

| | | Air | | Flow | | | | | | |
|---|---|---|---|---|---|---|---|---|---|---|
| | density | content | Slump | table | Strength (MPa) | | | Density (kg/m³) | | |
| Mix | (kg/m³) | (%) | (mm) | (mm) | 3 d | 7 d | 28 d | 3 d | 7 d | 28 d |
| Control-100PC | 1760 | 20 | 270 | 660 | 3.9 | 5.0 | 7.1 | 1806 | 1809 | 1836 |
| SSA-50PC | 1730 | 20 | 260 | 550 | 1.9 | 2.6 | 4.0 | 1726 | 1732 | 1725 |
| SSA-75PC | 1610 | 25 | 270 | 590 | 2.4 | 3.0 | 4.1 | 1574 | 1577 | 1567 |

The hardened properties of density and compressive strength are also given in Table 6. The control 100% PC mixture achieved compressive strength values of 3.9 MPa at 3 days, 5.0 MPa at 7 days, and 7.1 MPa at 28 days. The FC mixture made with 50% SSA (SSA-50PC) reached 1.9 MPa at 3 days and 4.0 MPa at 28 days, whereas the FC mixture made with 25% SSA (SSA-75PC) achieved slightly higher values of 2.4 MPa at 3 days and 4.1 MPa at 28 days. The results clearly show the possible use of SSA in the production of FC mixture of 4.0 MPa. The 25% SSA mixture (SSA-75PC) exhibited the lowest density values 1567-1577 kg/m³ compared to the PC mixtures with the highest values of 1725-1732 kg/m³. The SSA foam concrete exhibited average 7-day strength values of 2.6 and 3.0 MPa, higher than the UK specified value of 2.0 MPa. The results clearly show the developed SSA foam concrete mixtures follow the UK specifications for use in road reinstatement as subbase layer and below.

SSA Cement Bound Materials: Cement bound materials mixtures of CBM 1 and CBM 2, as per the QCS 2014, were developed based on fully replacing the PC with SSA and other activators and maximizing the use of recycled and local aggregates. The aggregates were natural rock, gravel, sand, or recycled aggregates. The activators used with SSA are lime and CKD. Details of the CBM mix designs are given in Table 7 together with the fresh density values.

TABLE 7
Mixtures of the CBM mixtures (kg/m³).

| | | | | | EW | RCA | | | | Density |
|---|---|---|---|---|---|---|---|---|---|---|
| Mix | SSA | PC | Lime | CKD | (5-40) | (5-20) | Sand | w/b | SS | (kg/m³) |
| CBM1-PC | — | 80 | — | | 1100 | 400 | 690 | 1.5 | 1.4 | 2390 |
| SSA1-Lime | 96 | — | 24 | | 1100 | 400 | 690 | 1.5 | 2.0 | 2400 |
| CBM2-PC | — | 120 | — | | 1070 | 410 | 710 | 0.92 | 2.0 | 2420 |
| SSA2 + 10CKD | 135 | — | — | 15 | 1070 | 410 | 710 | 0.8 | 2.0 | 2013 |
| SSA2 + 20Lime | 120 | | 30 | | 1070 | 410 | 710 | 0.8 | 2.0 | 2048 |

TABLE 8
Properties of CBM mixtures.

| | Strength (MPa) | | | Density (kg/m3) | | | Strength after | Retained |
|---|---|---|---|---|---|---|---|---|
| Mix | 3 d | 7 d | 28 d | 3 d | 7 d | 28 d | immersion (MPa) | Strength (%) |
| CBM1-PC | 4.1 | 4.7 | 7.1 | 2297 | 2330 | 2310 | 6.9 | 97% |
| SSA-Lime | 1.0 | 2.0 | 4.1 | 2278 | 2276 | 2242 | 3.5 | 87% |
| CBM2-PC | 13.7 | 16.8 | 21.2 | 2385 | 2405 | 2414 | 19.9 | 94% |
| SSA + 10CKD | 1.4 | 2.7 | 4.6 | 2294 | 2222 | 2151 | 4.2 | 91% |
| SSA + 20Lime | 1.3 | 2.1 | 3.9 | 2242 | 2218 | 2187 | 3.7 | 94% |

Two set of CBM mixtures were developed to include Set 1 and Set 2. Set 1: CBM1-PC with a binder content of 80 kg/m³, SSA1-Lime with a binder content of 120 kg/m³. Set 2: CBM2-PC with a binder content of 120 kg/m³, SSA2+10CKD and SSA2+20Lime with a binder content of 150 kg/m³. A summary of the results is given in Table 7 for the different CBM mixtures. The QCS 2014 specifies a minimum average 7-day compressive strength for CBM 1 of 4.5 MPa, with the strength of each individual cubes not less than 2.5 MPa. For CBM 2, the minimum average 7-day compressive strength is 7.0 MPa, with the strength of each individual cubes not less than 4.5 MPa. The QCS also specifies a durability requirement after immersion of the CBM cubes in water. The average compressive strength after immersion shall not be less than 80% of the average compressive strength in dry and sealed conditions.

For CBM1 mixtures, the CBM 1-PC, with a binder content of 80 kg/m³, gave a 7-day average strength of 4.7 MPa. The SSA1-20lime gave lower strength up to 2.0 MPa at 28 days, lower than the minimum specified value of 4.5 MPa. The retained strength was 87% exceeding the minimum requirement of 80% and indicating good durability of the SSA1-CBM mixtures.

For CBM2 mixtures, the CBM2-PC mixture, with 120 kg/m³ binder, exhibited the highest compressive strength values of 16.8 MPa at 7 days and 21.2 MPa at 28 days. These values are significantly high and may have detrimental effects on pavement cracking and performance. The SSA2 mixtures made with a total binder content of 150 kg/m³ gave much lower strength values that are more suitable for use in subbase in road construction. The SSA2+10CKD exhibited an average 7-day strength of 2.7 MPa, and 4.6 MPa at 28 days. Slightly lower values are given by the SSA2+20Lime of 2.1 MPa at 7 days and 3.9 MPa at 28 days. The CBM2 mixtures exhibited durable performance with retained strength values greater than 90%.

### Microstructural Analysis:

Different SSA green cement systems were assessed using various analytical techniques to determine their hydration behavior. Binder combinations were 100% SSA, 90% SSA+10% CKD, 80% SSA+20% lime (CH), 50% SSA+50% PC and a control 100% PC.

Mineralogical Composition: The mineralogical composition of SSA was determined by X-ray diffraction (XRD)—see FIG. 10. The results indicate that SSA consists primarily of whitlockite (Ca₁₈Mg₂H₂(PO₄)₁₄), with smaller quantities of hematite, maghemite, hydroxyapatite, albite, fosterite and quartz.

Hydrated Systems: Five binder systems were manufactured and hydrated with a 0.5 water to binder ratio and cured in sealed bags in a 30° C. oven. The pastes were cured for 2, 28 and 90 days, and tested for XRD, TGA and SEM to determine the mineralogical composition of each mix.

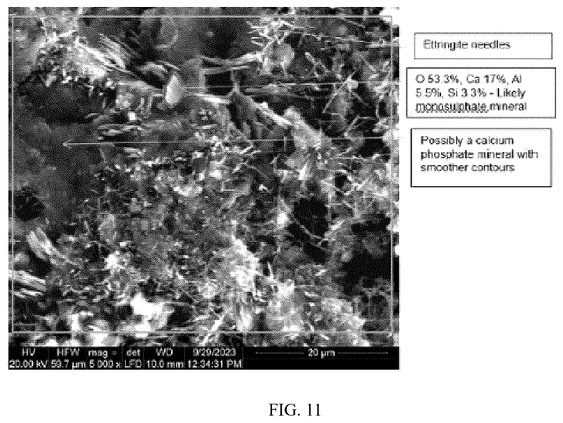

PC: During hydration the cement phases change to hydrates such as calcium silicate hydrate, calcium hydroxide and ettringite. As shown below, FIG. 11, as hydration progresses, the tricalcium silicate peaks decrease whilst the calcium hydroxide peaks increase.

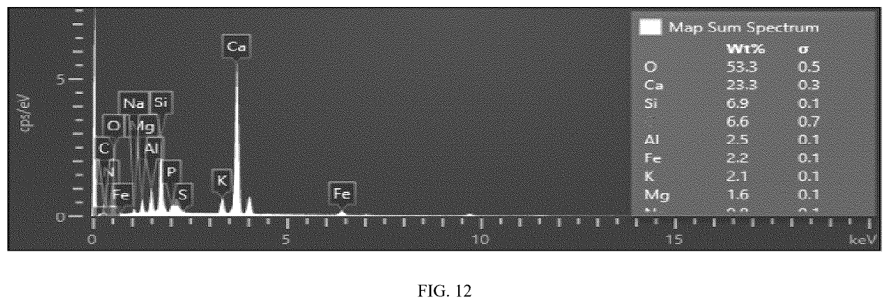

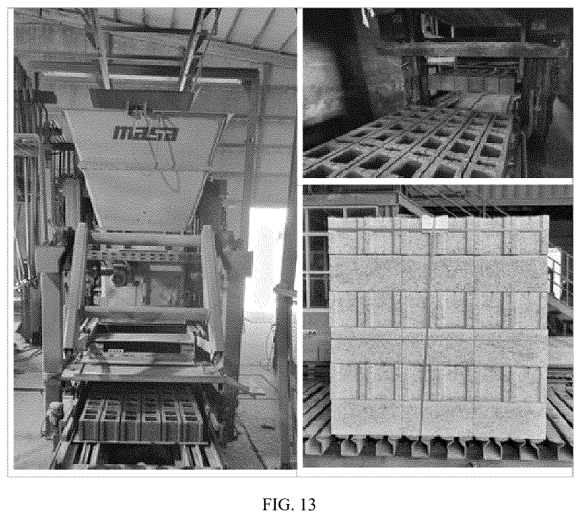

SSA: FIG. 12 superimposes the raw SSA with the binders containing 100% SSA. As shown below, hydration has had no impact on the minerals and no new phases have been formed. Accordingly, SSA could be considered inert in these conditions.

SSA (80%) and lime (20%) hydration: FIG. 13 superimposes the XRD traces of binders containing 80% SSA and 20% hydrated lime. Some of the minerals, such as whitlockite and hematite, remained unchanged. However, some unexpected changes do occur, such as: Calcite-the amount of calcite significantly decreases from 2 days to 28 days, and almost disappears after 90 days hydration. It seems the calcite has taken part in a reaction to form AFm minerals (e.g. carboaluminates). This indicates the presence of reactive forms of Al₂O₃ in the SSA. XRD didn't pick up the presence of reactive Al₂O₃ phases, hence the Al₂O₃ in SSA must be amorphous: Monosulphate (Ca+Al₂(SO₄)(OH)₁₂·6 H₂O=2 CaO·Al₂O₃·CaOH·CaSO₄)—this mineral has formed in small quantities after 90 days hydration. Coupled with the presence of carboaluminates, this indicates the presence of reactive Al₂O₃ phases in the SSA. The sulphate has come from the presence of hemihydrate in the SSA—see FIG. 13: Portlandite—as expected the amount of portlandite/CH increases from 2 to 28 days. However, thereafter, the quantity of CH decreases significantly. This is not due to carbonation but rather likely due to the formation of various AFm types of phases. Ettringite (Ca₆Al₂(SO₄)₃(OH)₁₂·26 H₂O)—Ettringite is apparent in the samples hydrated for 2 and 28 days. However, between 28 and 90 days ettringite disappears. The presence of ettringite indicates that SSA contains a source of reactive Al₂O₃. The disappearance of ettringite after 90 days hydration, will be due to additional aluminate phases reacting with ettringite to form monosulphate and with calcite and calcium hydroxide to form carboaluminates.

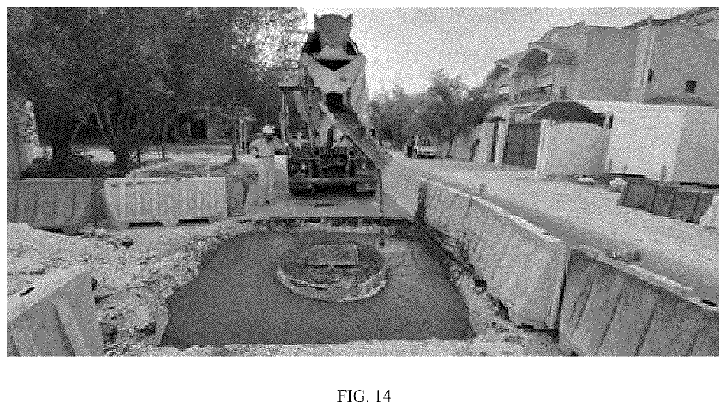

SSA (50%) and PC (50%) hydration: FIG. 14 superimposes the XRD traces of binders containing 50% SSA and 50% PC. Some of the minerals, such as whitlockite and hematite, remained unchanged. However, ettringite, which forms after 2 days hydration, is negligible after 90 days hydration. The ettringite converts to monosulphate at 28 and 90 days. Carboaluminates also form. Like the previous section, this result indicates the presence of reactive aluminates in the SSA.

SSA (90%) and CKD (10%) hydration: FIG. 15 superimposes the XRD traces of binders containing 90% SSA and 10% CKD. Some of the minerals, such as whitlockite and hematite, remained unchanged. Ettringite is present in this sample.

Scanning Electron Microscopy (SEM): High resolution SEM images were obtained to validate the mineral findings. Where possible, an elemental analysis was conducted (EDX) on a mineral of interest. This will help to determine the composition of the mineral and in some cases identification of the mineral if morphological details allow:

SSA hydration: The main minerals evident from the SEM on hydrated SSA sample are calcium phosphates with Fe, Si, Mg or Al inclusions. FIG. 16 shows a large Phosphate mineral in the centre of the image (highlighted), with smooth surface texture. This mineral also has other smaller particles attached to its surface: they are also Phosphate minerals of different composition. The elemental composition of the blue/teal highlighted area is given in FIG. 17, which also includes the composition of the smaller surface particles found in the highlighted area. Results confirm the findings from the XRD analysis of raw SSA.

SSA (80%) and CH (20%) hydration: The main minerals noted from SSA+CH sample are calcium hydroxide, ettringite and phosphate minerals. The elemental composition of the area in FIG. 18, presented in FIG. 19, shows Calcium, Silicon, Iron, Potassium, Phosphorous and Aluminum as the main elements. In FIG. 18, the needle like ettringite crystals and plate like Calcium hydroxide are spread throughout. XRD results showed that ettringite disappeared between 28 to 90 days of hydration. But they are visible in FIG. 18, despite the sample being 90 days of age. It is likely that these minerals are transforming into monosulphates and the quantity of the remaining ettringites are low compared to monosulphates. The background (visible above the highlighted area) is likely to be a combination of monosulphate and other calcium phosphate mineral.

SSA (50%) and PC (50%) hydration: Ettringite needles are visible in FIG. 20. They are seen to be emanating from or fusing into other cementitious minerals, possibly CSH or monosulphate. The plate like substance highlighted in red contour is monosulphate. The SSA contributed to the calcium phosphate mineral background, as labelled in FIG. 20. The elemental composition of blue/teal highlighted area is shown in FIG. 21. This information confirms the mineral phases from XRD results.

SSA (90%) and CKD (10%) hydration: FIG. 22 shows calcium silicate hydrate with protruding ettringite needles. Elemental composition of the blue/teal highlighted area is given in FIG. 23. It confirms the main elements as O, Ca, Si, Fe, P, Al and S. The area analyzed may not be exact and elements such as P can be picked up from minerals outside the field of view or just beneath the surface. This explains why other elements such as C, Fe and P are appearing in the analysis. In other images, calcium phosphorus minerals are evident.

### SSA Preparation and Economic Impact:

Approximately 800 thousand cubic meters of municipal wastewater are collected daily in Qatar for treatment, accounting for 292 million cubic meters per year. The quantity of municipal wastewater is expected to increase with increased population in Qatar. The solid content of sewage sludge is 0.16 kg per cubic meter, accounting for 128 tons per day and 47,000 tons per year. The sewage sludge is processed into pellets and currently the product has no commercial value and is available for use free of change.

The sludge needs to be processed through incineration and grinding to produce green cement. Conventional equipment is used in the disclosed technology. Sludge incineration 800-900° C. significantly reduces the weight of pellets, approximately by 67% of original weight. The quantity of SSA is relatively small compared to approximately 4-5 million tons of PC used annually in Qatar. The high cement production reflects the large market in the construction industry to consume all SSA produced in Qatar.

SSA was used for the production of non-structural concrete products of concrete blocks, foam concrete and cement bound materials. These products are generally characterized with compressive strength values below 10 MPs, and widely used in Qatar for the construction of building and fences (concrete blocks), backfill applications (foam concrete) and road base and subbase applications (cement bound materials). Table 8 provides the calculated costs of SSA concrete products in comparison to the conventional PC products.

TABLE 8
Costs of SSA concrete products (QR/m³).

| | Conc. Blocks | Cont. Blocks | Foam Conc. | Foam Conc. | CBM | CBM |
|---|---|---|---|---|---|---|
| | 100% PC | 10% SSA | 100% PC | 40% SSA | 100% PC | 80% SSA |
| Dune sand | 2.25 | 2.25 | 0 | 0 | 0 | 0 |
| Washed sand | 9.9 | 9.9 | 33.66 | 33.66 | 15.18 | 15.18 |
| Wadi gravel | 29.25 | 29.25 | 0 | 0 | 0 | 0 |
| Imported aggregate | 0 | 0 | 0 | 0 | 0 | 0 |
| Recycled aggregate | 33.6 | 33.6 | 0 | 0 | 42 | 42 |
| SSA | 0 | 7.2 | 0 | 24.96 | 0 | 23.04 |
| Lime | 0 | 0 | 0 | 0 | 0 | 9.6 |
| CKD | 0 | 0 | 0 | 0 | 0 | 0 |
| PC | 72.9 | 65.61 | 63.18 | 37.908 | 19.44 | 0 |
| Superplasticizer | 0.01 | 0.01 | 0.02 | 0.02 | 0.01 | 0.01 |
| Foaming agent | 0 | 0 | 0.01 | 0.01 | 0 | 0 |
| Water | 1.13 | 1.13 | 1.83 | 1.83 | 0.9 | 0.9 |
| Total | 149.04 | 148.95 | 98.69 | 98.38 | 77.53 | 90.73 |

The costs provided in Table 8 are based on the quantities of materials used in each concrete products (kg/m³) and the unit cost of each constituent in terms of Qatar Riyals per tons of material (QR/ton). For concrete blocks, the total cost of materials required for the production of one cubic meter is QR 149.04, with approximately half of the cost for the PC binder. Replacing 10% of the PC with SSA, marginally reduce the cost to QR 148.95. Similarly, the use of 40% SSA in foam concrete slightly reduce the cost from QR 98.69 for 100% PC to QR 98.38. A higher variation in cost is obtained for the CBM application. The cost of 80% SSA+20% lime is QR 90.73, approximately 17% higher than the 100% PC CBM mixture (QR 77.53). This is mainly attributed to the increased binder content of the 80% SSA CBM, which is 50% higher than the binder content in 100% PC CBM, resulting in more consistent mix design and enhanced performance compared to the 100% PC mixture.

In general, the cost of SSA concrete products is almost the same for the PC products, considering the marginal variation costs of SSA processing and market price of PC. However, there is an additional benefit for the resource recovery from SSA to avoid landfilling. In 2022, it was estimated that approximately 0.5 million cubic meter of foam concrete was used in Qatar for backfill applications, consumed approximately 130 thousand tons of PC. If foam concrete is to be made with SSA, the full production of SSA could be easily consumed in foam concrete.

Heavy metals are part of the contaminants available within the sewage sludge from municipal wastewater treatment plants. The use of SSA as green cement reduces the demand for cement and contributes to sustainable construction by using waste materials that would have been landfilled. In addition, SSA green cement has potential for encapsulating heavy metals in the matrix of hydrated products, thereby reducing the leaching of heavy metals to the environment.

Table 9 shows the heavy metal concentrations of the SSA (incinerated sewage sludge ash) and also for the green cement, incorporating SSA blended with lime-based activators. The results show substantial reduction in the concentration of heavy metals in the SSA green cements. The average concentration reduction of Cu, Cr, Pb, Ni and Zn heavy metals ranged between 65% to 75% for the different SSA binder systems. The other heavy metals were lower than the testing detection limits.

TABLE 9
Heavy metal concentrations of SSA and concrete-containing SSA (mg/kg).

| | | 25% SSA + 75% | 50% SSA + 50% | 90% SSA + 10% | 80% SSA + 20% |
|---|---|---|---|---|---|
| Element | SSA | PC | PC | CKD | Lime |
| Arsenic (As) | <6.2 | <6.2 | <6.2 | <6.2 | <6.2 |
| Cadmium (Cd) | <1.0 | <1.0 | <1.0 | <1.0 | <1.0 |
| Chromium (Cr) | 183.4 | 46.41 | 55.7 | 60.3 | 53.15 |
| Copper (Cu) | 1123 | 144.6 | 256.1 | 394.7 | 314.6 |
| Lead (Pb) | 21.3 | 6.60 | 7.262 | 9.95 | 7.44 |
| Mercury (Hg) | <0.2 | <0.2 | <0.2 | <0.2 | <0.2 |
| Nickel (Ni) | 106 | 20.49 | 29.31 | 39.7 | 32.02 |
| Selenium (Se) | <0.4 | <0.4 | <0.4 | <0.4 | <0.4 |
| Zinc (Zn) | 1643 | 298.5 | 439.2 | 601 | 485.7 |

Blending SSA with PC significantly reduced the leachability of heavy metals compared to SSA. The greatest reduction of 87% was for copper (Cu), with values of 1123 mg/kg for SSA and 144.6 mg/kg for 25% SSA+75% PC. In fact, blending SSA with PC reduced the Cu concentration to lower values than the maximum specified in the QCS 2014 of 1000 mg/kg, making it more environmental-friendly resource. Great reductions were also achieved in the concentration of Cr, Pb, Ni, and Zn heavy metals.

SSA-lime blend was also found efficient in immobilizing heavy metals. Again, the greatest reduction of heavy metal leaching was found for the Cu between 1123 mg/kg for SSA and 256.1 mg/kg for the blend of 80% SS+20% Lime, a reduction of 67% to fully comply with the QCS 2014 requirements. Similarly, the SSA-CKD blend converted the SSA into a fully compliant material with the QCS requirements.

While the SSA-PC blends exhibited the lowest heavy metal leaching values, these blends contain lower contents of SSA compared to other mixes made with SSA-lime and SSA-CKD. The green cement made with SSA-lime and SSA-CKD contained 80% and 90% of SSA, respectively, by weight of binder. The green cement products developed in the present technology showed significant reductions in the leachability of heavy metals to fully comply with the stringent QCS requirements for use in environmental-friendly concrete products.

A carbon footprint assessment was undertaken for sewage sludge ash (SSA) produced at Doha North Wastewater Treatment Plant (DNWWTP), together with concrete products made with SSA. The concrete products made with SSA were designed on the basis of similar performance to the conventional products made with PC. The calculations have been undertaken in accordance with PAS 2050 (BSI, 2011), and consider impacts from cradle to gate only. Cradle to grave assessment considers all life cycle stages from raw material extraction right up to disposal at end of life (BSI, 2011), as shown in FIG. 24. In comparison, cradle to gate assessment considers all life cycle stages from raw material extraction up to the point to the factory ‘gate’ i.e. the point in the life cycle where the respective concrete products have been produced and are ready to be transported and applied in construction projects in Qatar.

Table 10 shows GHG emissions for each stage of production of SSA from sewage sludge cake. The total GHG emissions for the “most likely” scenario are 1.13 kgCO₂e/kg of ground SSA. Of this the majority of GHG emissions (0.82 kgCO₂e/kg of ground SSA) are produced from combusting LPG during incineration, followed by 0.24 kgCO₂e/kg of ground SSA from emission from burning the organic material in the dried sewage sludge pellets.

TABLE 10
GHG emissions for each stage of SSA production, for both the
“most likely” and lower bound” scenarios.

| | “Most likely” scenario |
|---|---|
| Process | (kgCO₂e/kg of ground SSA) |
| Thermal drying - LPG | 1.72 |
| Thermal drying - Electricity | 0.25 |
| Incineration - LPG | 0.82 |
| Incineration - Fresh water | 0.05 |
| Incineration - Recycled water | 0.00 |
| Incineration - Waste water | 0.00 |
| Incinerator - Burning SS pellets | 0.24 |
| Grinding - Electricity | 0.02 |
| Total | 3.10 |

The GHG emissions of the developed SSA concrete products are summarized in Table 11.

TABLE 11
GHG emissions (gCO₂e/m³) for each stage of SSA concrete products.

| | Blocks | Blocks | Foam (100% | Foam (4055A + | CBM (100% | CBM (8055A + |
|---|---|---|---|---|---|---|
| | (100% PC) | (1055A + 90PC) | PC) | 60PC) | PC) | 20Lime |
| Materials | 0.00 | 0.00 | 0.00 | 0.00 | 0.00 | 0.00 |
| Dune sand | 0.765 | 0.765 | | | 1.173 | 1.173 |
| Washed sand | 0.765 | 0.765 | 2.601 | 2.601 | | |
| Wadi gravel | 4.745 | 4.745 | | | | |
| Recycled | 3.600 | 3.600 | | | 4.500 | 4.500 |
| aggregate | | | | | | |
| Hydrated lime | | | | | | 22.560 |
| PC (CEM1) | 258.00 | 232.20 | 223.60 | 134.16 | 68.80 | |
| Admixtures | 9.40 | 9.40 | 15.98 | 15.98 | 3.76 | 3.76 |
| Water | 0.612 | 0.612 | 0.9955 | 0.9955 | 0.49 | 0.49 |
| SSA | | 33.90 | | 117.52 | | 106.22 |
| Processing | | | | | | |
| Electricity | 1.953 | 1.953 | 1.953 | 1.953 | 1.953 | 1.953 |
| Water | 0.00001 | 0.00001 | 0.00001 | 0.00001 | 0.00001 | 0.00001 |
| Wastewater | negligible | negligible | negligible | negligible | negligible | negligible |
| Transport | | | | | | |
| Dune sand | 1.00860 | 1.00860 | | | | |
| Washed sand | 1.48718 | 1.48718 | 5.05642 | 5.05642 | 2.28035 | 2.28035 |
| Wadi gravel | 1.45687 | 1.45687 | | | | |
| Recycled | 2.68960 | 2.68960 | | | 3.36200 | 3.36200 |
| aggregate | | | | | | |
| Hydrated lime | | | | | | 0.02385 |
| PC (CEM1) | 0.99145 | 0.89231 | 0.85926 | 0.51556 | 0.26439 | |
| Admixtures | 0.01088 | 0.01088 | 0.01850 | 0.01850 | 0.00435 | 0.00435 |
| Water | 0.11927 | 0.11927 | 0.19402 | 0.19402 | 0.09542 | 0.09542 |
| SSA | | 0.06530 | | 0.22638 | | 0.20461 |
| Total | 286.84 | 294.91 | 247.88 | 275.84 | 86.68 | 146.63 |

Total GHG emissions for the 100% PC blocks were 286.84 kgCO₂e/m³, while total GHG emissions were 294.91 kgCO₂e/m³ for the 90% PC/10% SSA blocks. In both products, the majority of these emissions are associated with the material stage. The most significant contributing materials are PC for the 100% PC blocks and PC and SSA for the 90% PC/10% SSA blocks. The carbon footprint of the blocks containing SSA is only slightly (3%) larger than the carbon footprint of the 100% PC blocks.

For the foam concrete, the total GHG emissions for the 100% PC foamed concrete and 60% OPC/40% SSA foamed concrete were 247.88 kgCO₂e/m³ and 275.84 kgCO₂e/m³, respectively. Again, in both cases the majority of these emissions are associated with the material stage.

The carbon footprint of the foamed concrete containing SSA is somewhat (11%) larger than the carbon footprint of the 100% PC foamed concrete. This is because a larger amount of PC was replaced with SSA than for the concrete blocks.

The total GHG emissions for the 100% PC cement bound material were 86.68 kgCO₂e/m³ and 146.63 kgCO₂e/m³ for 80% SSA/20% lime cement bound materials and in both cases the majority of these emissions are associated with the material stage. The carbon footprint of the SSA cement bound material is about 70% larger than the carbon footprint of the 100% PC cement bound material. This is because the 50% higher binder content used for the 80% SSA/20% lime mixture.

As previously noted, conventional equipment was used for the processing of SSA and calculations of carbon footprints with no consideration of the high calorific value of the sludge and the significant reduction in fuel and energy through the co-combustion of the sludge. Significant reduction in the calculated carbon footprint is expected by considering calorific value and co-combustion of the sludge.

### Production of SSA Concrete Blocks:

Working in partnership with industry has enabled the mix designs developed for SSA mixtures to be practically applied in practice. Concrete blocks were produced in July 2023 in the factory of Fahad Bin Abdulla at the Industrial Area of Doha. Three mixtures were of concrete blocks were produced, with the mix composition given in Table 12.

TABLE 12
Mix composition of the concrete blocks (kg).

| Mix | Control-100% PC | SSA-10% | SSA-20% |
|---|---|---|---|
| PC | 300 | 270 | 240 |
| SSA | — | 30 | 60 |
| Washed sand - 5 mm | 450 | 450 | 450 |
| Dune sand - 3 mm | 450 | 450 | 450 |
| CDW - 10 mm | 1200 | 1200 | 1200 |
| Wadi gravel - 10 mm | 650 | 650 | 650 |
| Water | 150 | 150 | 150 |
| Superplasticiser | 5 | 5 | 5 |
| Total | 3206 | 3206 | 3206 |

The control mix was made with 100% PC and was given the code of 100% PC. The SSA mixtures were made by replacing 10% and 20% by weight of PC with SSA and were given the codes of “SSA-10%” and “SSA-20%”, respectively. Hollow blocks were made from the three mixtures, approximately 160 blocks from each mix of the dimensions of 200×200×400 mm. The concrete ingredients were mixed thoroughly and fed into the block making machine. The fresh concrete was shaped and compacted, using a vibrated pressure machine under a hydraulic pressure of 165 bars for 5 seconds. Hollow blocks of 400×200×200 mm were produced as shown in FIG. 25. No difference in the production process was observed due to the use of SSA. The freshly compacted blocks are moved onto a flat pallet using a conveyor and transferred into curing room maintained at 40±2° C. and 65±5% relative humidity for 1 day. After curing, the blocks are rolled out of the curing room and are aligned into pallets of 108blocks each and stored outdoors until testing.

Table 13 presents the compressive strength and water absorption results of the concrete blocks made with PC and SSA binders. The Control 100% PC and the 10% SSA concrete blocks exceeded the minimum compressive strength requirement for external non-load bearing walls, with average strength values of 8.8 MPa and 8.0 MPa, respectively. The lowest individual block strength was also greater than the minimum requirement of 5.6 MPa. The 20% SSA achieved a lower average compressive strength of 6.1 MPa with the lowest induvial block strength greater than 3.6 MPa, suitable for use in internal non-load bearing walls.

TABLE 13
Properties of concrete mixtures for blocks.

| | | Control- | | |
|---|---|---|---|---|
| | Block No. | 100% PC | SSA-10% | SSA-20% |
| Compressive | 1 | 9.0 | 6.9 | 6.1 |
| Strength (MPa) | 2 | 9.7 | 10.3 | 6.3 |
| | 3 | 7.9 | 6.7 | 5.8 |
| | 4 | 8.2 | 8.3 | 6.6 |
| | 5 | 8.8 | 7.6 | 6.2 |
| | 6 | 9.1 | 7.9 | 5.7 |
| | Average | 8.8 | 8.0 | 6.1 |
| | Strength | | | |
| Water | 7 | 5.8 | 4.6 | 4.9 |
| Absorption (%) | 8 | 4.3 | 4.6 | 5.1 |
| | 9 | 3.8 | 5.1 | 4.8 |
| | Average | 4.6 | 4.8 | 4.9 |
| | Absorption | | | |

The average water absorption values of the three mixtures ranged between 4.6% and 4.9%, lower than the maximum specified limit of 7% in the QCS 2014. The lowest average absorption value was found for the Control 100% PC mixture, whereas the highest was for the 20% SSA mixtures. For the individual concrete blocks, the highest value was 5.6% for the Control 100% PC that is lower than the maximum specified limit of 7.5%. The results encourage the use of 10% SSA for concrete blocks that comply with the QCS 2014 strength requirement for external non-load bearing walls.

### SSA Foam Concrete for Road Reinstatement:

Foam concrete (FC) is widely used as a backfill material in Qatar, with estimated 0.5 million cubic meters of materials consumed in 2022. FC has many advantages compared to conventional concrete in terms of high flowability, lightweight, controlled low strength, minimal consumption of aggregate, and good thermal insulation properties.

Depression around manhole covers is a common pavement defect due to the difficulty of compacting around the round-shape of manhole covers. The Road Maintenance and Operations Department (ROMD) at Ashghal developed a procedure for the reinstalment around manhole covers, as given in the Amendment to the Code of Practice and Specification for Road Openings in the Highway, to include the use of foam concrete. The foam concrete is specified based on a characteristic 28-day compressive strength of 5 MPa.

SSA foam concrete was used for the development of foam concrete and used for the reinstatement of manhole cover as shown in FIG. 26. Two foam concrete mixtures were considered in the site trials with the mix compositions given in Table 13. Both mixtures were made with the same binder content of 260 kg/m³. A blended SSA (40%) and PC (60%) binder was used for the production of the SSA foam concrete. The other ingredients of foam concrete were kept the same for both mixtures including the mixing water, superplasticizer (SP) and foaming agent of synthetic foam.

TABLE 14
Mix proportions of foamed concrete (kg/m³).

| | Binder | | | | SP | |
|---|---|---|---|---|---|---|
| Mix | PC | SSA | Sand | Water | (l/m³) | Foam |
| Control-PC | 260 | — | 1530 | 244 | 6.0 | 2.5 |
| 40SSA-60PC | 156 | 104 | 1530 | 244 | 6.0 | 2.5 |

The fresh and hardened properties of foam concretes are given in Table 15 The density results were 1583, and 1560 kg/m³ for the PC and SSA foam mixtures, respectively. The results indicate a lightweight foam concrete with density below 1600 kg/m³, with a small variation between the PC and SSA foam concrete mixtures. Both mixtures had high flowability and air content. The average 28-day compressive strength were reported for cubes and cores. The control PC exhibited a cube strength of 4.1 MPa and core strength of 3.5 MPa, whereas the SSA foam concrete gave 3.6 MPa and 4.1 MPa, respectively.

TABLE 15
Properties of the fresh FC mixtures.

| | | | | 28-d Strength | |
|---|---|---|---|---|---|
| | Wet density | Air | Flow table | (MPa) | |
| Mix | (kg/m³) | content (%) | (mm) | Cubes | Cores |
| Control-PC | 1,583 | 27 | 680 | 5.2 | 3.6 |
| 40SSA-50PC | 1,560 | 25 | 670 | 3.5 | 4.2 |

In general, the results indicate the successful use of SSA in the production of green cement, made of 40% SSA and 60% PC, for use in foam concrete and backfill applications. The SSA foam concrete achieved compressive strength values within the range of 3-4 MPa with excellent durability performance. While the strength is slightly lower than for the Control PC foam concrete, the strength provided is expected to be consistent to support pavement structural layers and enhance the bearing capacity of road openings. The main advantages of SSA foam concrete are for the reduced use of PC binder and its negative impact on the environment, ease of placement without compaction, ease of excavation with simple tools, and less on-site labor and equipment requirements due to its high flowable nature

### Development of SSA Binder Systems:

Different binder systems were developed to include SSA activated with different proportions of PC, hydrated lime, cement kiln dust (CKD), and alkali solutions. SSA was found to mainly influence the setting time and strength development of the various binder systems. SSA was used to replace 25%, 50%, and 75% by weight of PC in C40 concrete. The control 100% PC mortar gave a 28-day strength of 43.5 MPa, with a reduction of 19%, 49%, and 66% for increased SSA content.

At the same water to binder ratio, increasing the CH content improves the workability and strength of mortar. Increasing the CH content from 20% to 30% in the SSA binder system has marginal effect strength increment.

Increasing the CKD content in the SSA binder system has adversely affected the workability of mortar. The SSA-CKD system exhibited relatively high strength at 2 days, but the rate of strength development reduced with age. The best strength results were found for the SSA-10% CKD.

Chemical activators of sodium hydroxide (N) and sodium silicate (SS) were used to activate the SSA at different values of alkali content and silicate modulus. The best workability results were found at alkali content (N) of 6%. The compressive strength of the alkali-activated SSA systems were in the range of 1.9 MPa to 8.7 MPa, whereas a higher range of 12.7 MPa and 29.3 MPa for the SSA-GGBS system.

Microstructural analysis of the SSA-lime system showed a dense microstructure with the formation of calcium phosphates and calcium carbonate that contribute to concrete strength.

The alkali-activated SSA systems with high silicate modulus (Ms of 1.5) showed similar hydration products to that of the SSA-lime system, but with a porous microstructure and the presence of microcracks, especially at high alkali content.

### Development of SSA Concrete Products:

SSA products of concrete blocks, foam concrete and cement bound materials were successfully developed in the laboratory and compared to conventional products made with PC.

Replacing 25% of PC with SSA was effective to produce concrete block mixtures in the laboratory to satisfy the QCS requirements of compressive strength and water absorption.

The SSA-10CKD slightly exceeded the strength requirement, whereas the SSA-20Lime failed to achieve the required strength. Based on the results, the SSA-PC system was selected for the development of the concrete blocks.

SSA was used to replace 50% and 75% of PC in the production of foam concrete, with density values between 1500 and 1800 kg/m³ and air content of 20-25%. The SSA mixtures exhibited excellent fresh properties of workability and flowability with no segregation or bleeding. The 28-day compressive strength was at least 4.0 MPa for use as backfill and road construction.

Cement bound material (CBM) mixtures were made with SSA replacing 100% of PC. SSA was activated by 10% CKD or 20% hydrated lime to provide CBM mixtures with adequate strength and excellent durability performance for use in road construction.

Environmental and cost assessments were made on the newly developed SSA green cement and concrete products. The green cement products exhibited substantial reductions in heavy metal concentrations due to the solidification of these contaminants within the hydration products of concrete. The carbon footprint calculation indicated approximately 30% higher total greenhouse gas emissions for SSA, compared to PC. Sewage sludge pellets have no current commercial value, and the cost of processing through incineration and grinding was found exactly the same as the market price of the PC.

The new SSA green cement and binder systems offer the benefits of resource recovery from sewage sludge waste, reduce reliance on energy-intensive PC, and support the green and sustainable construction in Qatar.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A green cement concrete block comprised of:
sewage sludge ash (SSA);
Portland cement (PC);
chemical activator; and
water.

2. The green cement concrete block of claim 1, wherein the green cement block is 10% SSA.

3. The green cement concrete block of claim 1, wherein the chemical activator is one of sodium hydroxide, sodium silicate, or cement kiln dust (CKD).

4. The green cement concrete block of claim 3, wherein the chemical activator is CKD, and the green cement block is 10% CKD.

5. The green cement concrete block of claim 1, wherein the green cement block has an alkali content of 6%.

6. The green cement concrete block of claim 1, further comprising superplasticizer, the green cement block is 2% superplasticizer is 2%.

7. The green cement concrete block of claim 1, further comprising aggregates.

8. The green cement concrete block of claim 7, wherein the aggregates are one of natural rock, gravel, sand, or recycled aggregates.

9. A green foam concrete comprised of:
sewage sludge ash (SSA);
Portland cement (PC);
superplasticizer (SP);
foaming agent;
sand; and
water.

10. The green foam concrete of claim 9, wherein the green foam concrete is 40% SSA.

11. The green foam concrete of claim 9, wherein the foaming agent is synthetic foam.

12. The green foam concrete of claim 9, wherein the superplasticizer dosage is 2 l/m³.

13. The green foam concrete of claim 9, wherein the foaming agent dosage is between 1.2 and 1.4 kg/m³.

14. The green foam concrete of claim 9, wherein the sand content is 260 kg/m³.
